(19) United States
(12) Patent Application Publication
(10) Pub. No.: US 2018/0349321 A1
(43) Pub. Date: Dec. 6, 2018

(54) PARALLEL PROCESSING APPARATUS, PARALLEL OPERATION METHOD, AND PARALLEL OPERATION PROGRAM

(71) Applicant: FUJITSU LIMITED, Kawasaki-shi (JP)

(72) Inventors: Hideyuki Shitara, Toda (JP); Akira HOSOI, Atsugi (JP); Ryoji TANDOKORO, Fujisawa (JP)

(73) Assignee: FUJITSU LIMITED, Kawasaki-shi (JP)

(21) Appl. No.: 15/995,315

(22) Filed: Jun. 1, 2018

(30) Foreign Application Priority Data
Jun. 5, 2017 (JP) 2017-110983

(51) Int. Cl. G06F 17/16; G06F 17/12; G06F 15/173; G06F 17/50

(52) U.S. Cl. CPC G06F 17/16; G06F 17/12; G06F 2217/16; G06F 17/5009; G06F 15/173

(57) ABSTRACT

A parallel processing method for performing operation for each row data of matrix data and outputting solution data for each row, for solving matrix simultaneous linear equations, by using at least one of the Gauss-Seidel method and the SOR method using matrix data, the parallel operation method including: performing parallel operation on elements at a right side of diagonal elements of the matrix data for each of rows of the row data to calculate right-side operation result data; performing parallel operation on elements at a left side of the diagonal elements of the matrix data for each of rows of the row data using a solution data to calculate left-side operation result data; and calculating the solution data of the diagonal elements of the matrix data of the row data using the right-side operation result data and the left-side operation result data.

### CROSS-REFERENCE TO RELATED APPLICATION

This application is based upon and claims the benefit of priority of the prior Japanese Patent Application No. 2017-110983, filed on Jun. 5, 2017, the entire contents of which are incorporated herein by reference.

### FIELD

The embodiments discussed herein are related to a parallel processing apparatus, a parallel operation method, and a parallel operation program.

### BACKGROUND

In a numerical simulation, such as a fluid analysis, a structural analysis, or the like, it is often the case that the portion of solving sparse matrix simultaneous linear equations Ax=b (A: sparse matrix, x: solution vector, and b: partial vector) occupies the most part of the execution time of the simulation. Accordingly, it is very important to increase the speed of solving sparse matrix simultaneous linear equations. A sparse matrix refers to a matrix in which most of the matrix elements are zero.

As a solution for large-scale sparse matrix simultaneous linear equations, an algorithm called an iteration method is used. In an iteration method, a certain initial value is given to x, and the solution is obtained by iterating an update operation of x until the difference between the true solution and x becomes less than or equal to a permissible error. The number of updates of x until the solution is obtained is called the number of iterations.

In an iteration method, in order to reduce the number of iterations as small as possible, preprocessing is performed. As an effective method of preprocessing, a multigrid method is provided. When preprocessing is performed using a multigrid method, a large part of the execution time is often occupied by a matrix calculation using the Gauss-Seidel method or the successive over-relaxation (SOR) method. Accordingly, it becomes important to increase the speed of the Gauss-Seidel method or the SOR method in order to effectively perform the preprocessing.

Here, FIG. 1 illustrates an overview of the Gauss-Seidel method. As the processing of (a) to (e) in FIG. 1 proceeds, the elements of a vector x are updated in order from x[0] to x[n−1]. The terms x[Acol[i][j]] ((d) in FIG. 1) and x[i] ((e) in FIG. 1) have a dependency relationship. Accordingly, the processing is performed sequentially as follows: calculation of i=0-th row is performed, next, calculation of i=1st row is performed, calculation of i=2nd row is performed, and so forth.

When a matrix A is a sparse matrix, a row i1 and a row i2 do not have a non-zero element at the same column position with each other. That is to say, there is sometimes no dependency relationship between x[Acol[i1][j]] and x[i2], and there is no dependency relationship between x[Acol[i2][j]] and x[i1]. In that case, it is possible to perform calculation of the two rows i1 and i2 in parallel. That is to say, it is possible to update the values of x[i1] and x[i2] at the same time.

The above-described fact results in changing the original update order of the vector x, that is to say, updating in the order from x[0] to x[n−1], and thus the number of iterations increases.

On the other hand, as a different solution for simultaneous linear equations from the Gauss-Seidel method and the SOR method, an LU decomposition method for decomposing a square matrix into a lower triangular matrix L and an upper triangular matrix U is provided. When solving the simultaneous linear equations using the LU decomposition method, the K-th iteration processing is decomposed into sequential processing P and processing Q that is possible to be parallelized, the processing Q is decomposed into Q1 to Qn, and Q1 and P(K+M) is sequentially executed by one processor. A proposal has been made that in parallel with the processing, other processing Q2 to Qn is executed by the other processor in parallel, and processing order is guaranteed in order to reduce the waiting state time of the processor (for example, refer to Japanese Laid-open Patent Publication No. 8-227405).

However, the LU decomposition method described above is a method that is designed for a dense matrix including many non-zero elements and differs from the Gauss-Seidel method and the SOR method that are designed for a sparse matrix including many zero elements. Also, the LU decomposition method described above is a direct method and differs from the Gauss-Seidel method and the SOR method, which are iteration methods, in the way of obtaining a solution. Accordingly, by the LU decomposition method described above, the degree of parallelism in operation decreases as the operation proceeds so that it is not possible to carry out at least one of the Gauss-Seidel method and the SOR method for a sparse matrix at a high speed.

### SUMMARY

According to an aspect of the invention, a parallel processing method for performing operation for each row data of matrix data and outputting solution data for each row, for solving matrix simultaneous linear equations, by using at least one of the Gauss-Seidel method and the SOR method using matrix data, the parallel operation method including: performing parallel operation on elements at a right side of diagonal elements of the matrix data for each of rows of the row data to calculate right-side operation result data; performing parallel operation on elements at a left side of the diagonal elements of the matrix data for each of rows of the row data using a solution data to calculate left-side operation result data; and calculating the solution data of the diagonal elements of the matrix data of the row data using the right-side operation result data and the left-side operation result data

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an overview of the Gauss-Seidel method;

FIG. 2 is a diagram illustrating another example of an overview of the Gauss-Seidel method;

FIG. 3 is a diagram illustrating an example of calculation of a 3×3 matrix by the Gauss-Seidel method;

FIG. 4 is a block diagram illustrating an example of the entire related-art parallel processing apparatus;

FIG. 5 is a flowchart illustrating an example of the processing flow of the entire related-art parallel processing apparatus;

FIG. 6 is an explanatory diagram of an example of the related-art Gauss-Seidel method;

FIG. 7 is a flowchart illustrating an example of the processing flow by the related-art Gauss-Seidel method;

FIG. 8 is a diagram illustrating an example of the calculation of a 16×16 matrix by the related-art Gauss-Seidel method;

FIG. 9 is a diagram illustrating an example of the hardware configuration of a parallel processing apparatus according to the present disclosure;

FIG. 10 is a block diagram illustrating an example of the entire parallel processing apparatus according to the present disclosure;

FIG. 11 is a flowchart illustrating an example of the processing flow of the entire parallel processing apparatus according to the present disclosure;

FIG. 12 is an explanatory diagram of an example of the Gauss-Seidel method according to the present disclosure;

FIG. 13 is a flowchart illustrating an example of the processing flow by the Gauss-Seidel method according to the present disclosure;

FIG. 14 is a diagram illustrating an example of the calculation of a 16×16 matrix by the Gauss-Seidel method according to the present disclosure;

FIG. 15 is a diagram illustrating an example of a division method of a sparse matrix according to an embodiment;

FIG. 16 is a diagram illustrating an example of the execution order of a divided sparse matrix according to a first embodiment; and

FIG. 17 is a diagram illustrating an example of the execution order of a divided sparse matrix according to a second embodiment;

### DESCRIPTION OF EMBODIMENTS

In the following, descriptions will be given of embodiments of the present disclosure. However, the present disclosure is not limited by these embodiments in any way.

In a parallel processing apparatus according to the present disclosure, when solving matrix simultaneous linear equations by at least one of the Gauss-Seidel method and the successive over-relaxation method (SOR method) using matrix data, operation is performed for each predetermined row data of the matrix data, and solution data is output for each row. The parallel processing apparatus includes a right-side operation result data calculation unit, a left-side operation result data calculation unit, a diagonal element solution data calculation unit, and further the other units as circumstances demand.

Gauss-Seidel Method

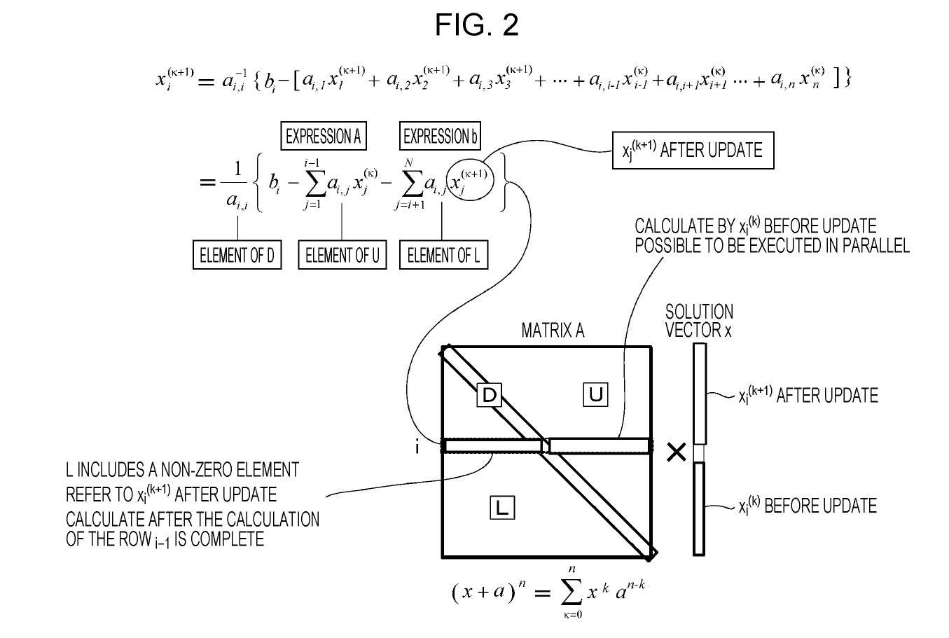

As illustrated in FIG. 2, the Gauss-Seidel method is a method of iteratively calculating recurrence relations for a simultaneous equation Ax=b so as to obtain the solution x. In the recurrence relations, element values of updated solution vector x are sequentially reflected.

In the Gauss-Seidel method, as a calculation method of a matrix A, the matrix A is divided into an upper right part “U” of the matrix A, a lower left part “L” of the matrix A, and a diagonal element part “D” of the matrix A, and each part is multiplied by a solution vector x.

In the Gauss-Seidel method, the “U” part of the matrix A is multiplied by xᵢ^{(k)} before update, and thus it is possible to execute in parallel.

In the Gauss-Seidel method, the “L” part of the matrix A is multiplied by xᵢ^{(k+1)} after update. That is to say, in the Gauss-Seidel method, xᵢ^{(k+1)} after update is referenced, and after calculation of the row (i−1) is complete, calculation is performed. In this manner, the Gauss-Seidel method has a dependency on the calculation order, and thus it becomes difficult to perform parallel execution.

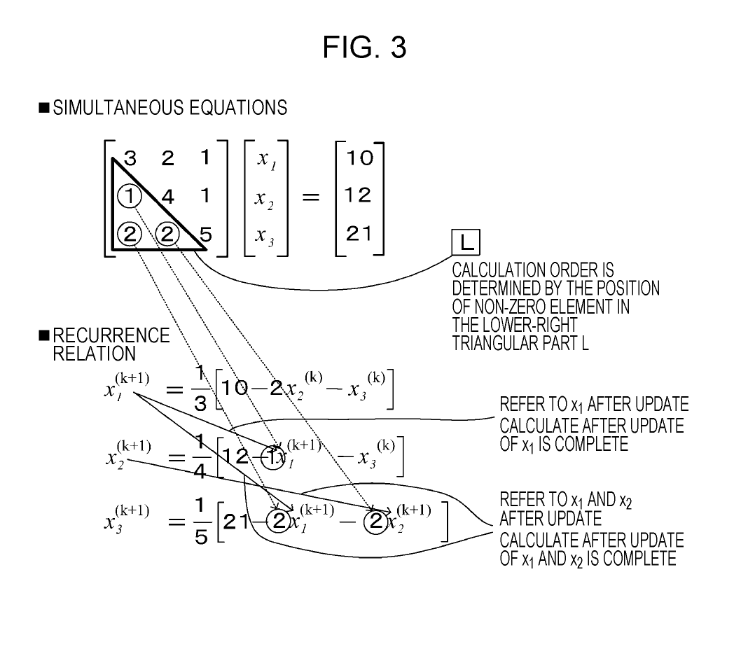

FIG. 3 is a diagram illustrating an example of calculation of a 3×3 matrix by the Gauss-Seidel method.

In the Gauss-Seidel method, in the recurrence relations of simultaneous equations, first, step of x₁^{(k+1)} is calculated. Next, when step of x₂^{(k+1)} is calculated, calculation has to be performed by referring to x₁ after update in the arrowed part. In the Gauss-Seidel method, when the next step of x₃^{(k+1)} is calculated, calculation has to be performed by referring to x₁ and x₂ after update in the arrowed part, and thus the processing has to be performed in order. In this manner, in the Gauss-Seidel method, calculation order is determined by the position of a non-zero element in the lower left triangular part of the simultaneous equations.

Successive Over-Relaxation Method (SOR Method)

The SOR method is a method for solving simultaneous linear equations with n unknowns Ax=b by an iteration method, and an acceleration parameter co is introduced to the Gauss-Seidel method so as to increase the amount of correction in order to further increase the speed.

An acceleration parameter co is given by the following expression.

$${ζ}_{i}^{( k )} = \frac{1}{{a}_{ij}} \{ {b}_{j} - ( {a}_{j 1} {x}_{1}^{( k )} + {a}_{j 2} {x}_{2}^{( k )} + ⋯ + {a}_{ij - 1} {x}_{i - 1}^{( k )} + {a}_{ij + 1} {x}_{ij + 1}^{( k - 1 )} ⋯ + {a}_{jn} {x}_{n}^{( k - 1 )} ) \}$$

$${x}_{i}^{( k )} = {x}_{i}^{( k - 1 )} + ω ( {ζ}_{j}^{( k )} - {x}_{j}^{( k - 1 )} )$$

$$( j = 1 , 2 , ⋯ , n ; k = 1 , 2 , ⋯ )$$

In the SOR method, in order to converge, co has to satisfy: 0<ω<2. In the case where 1<ω<2, the case corresponds to the over-relaxation method (SOR method). In the case where 0<ω<1, the case corresponds to the under-relaxation. In the case where ω=1, the case corresponds to the Gauss-Seidel method.

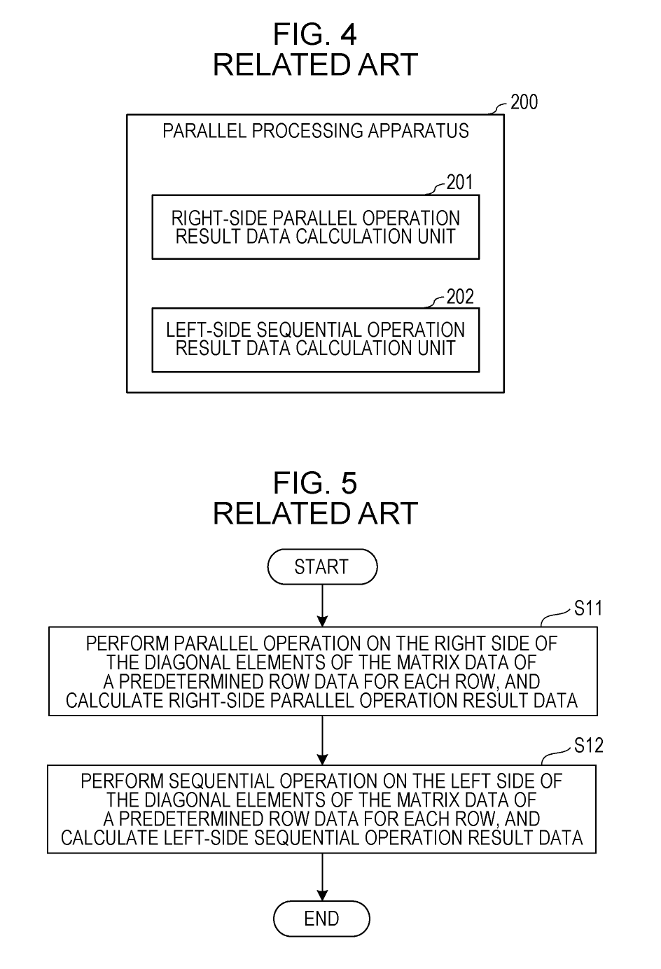

Here, FIG. 4 is a block diagram illustrating an example of the entire related-art parallel processing apparatus. A parallel processing apparatus 200 illustrated in FIG. 4 includes a right-side parallel operation result data calculation unit 201 and a left-side parallel operation result data calculation unit 202.

Next, FIG. 5 is a flowchart illustrating an example of the processing flow of the entire related-art parallel processing apparatus. In the following, a description will be given of the processing flow of the entire related-art parallel processing apparatus with reference to FIG. 4.

In step S11, the right-side parallel operation result data calculation unit 201 performs parallel operation on the right side of the diagonal elements of the matrix data of predetermined row data for each row to calculate the right-side parallel operation result data, and then the processing proceeds to S12.

In step S12, the left-side parallel operation result data calculation unit 202 performs sequential operation on the left side of the diagonal elements of the matrix data of predetermined row data for each row to calculate the left-side parallel operation result data, and then the processing is terminated.

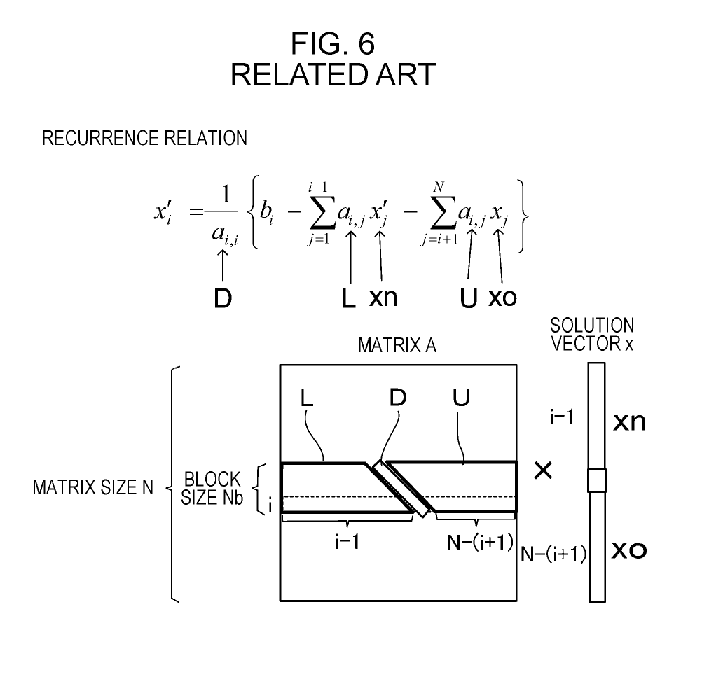

FIG. 6 is an explanatory diagram of an example of the related-art Gauss-Seidel method. Reference signs L and U in FIG. 6 are submatrices having a block size Nb in a matrix A having a matrix size N. Reference sign D is a diagonal matrix having the block size Nb in the matrix A having the matrix size N. Reference signs xn and xo are partial solution vectors of the solution vector x.

The block size Nb is not fixed and is suitably set in accordance with the number of non-zero elements. Because the matrix A includes zero elements and non-zero elements other than zeros, and when calculation is performed, calculation is performed based on non-zero elements, and thus it is difficult to determine in the same way. Accordingly, the block size Nb is suitably determined in accordance with the number of non-zero elements.

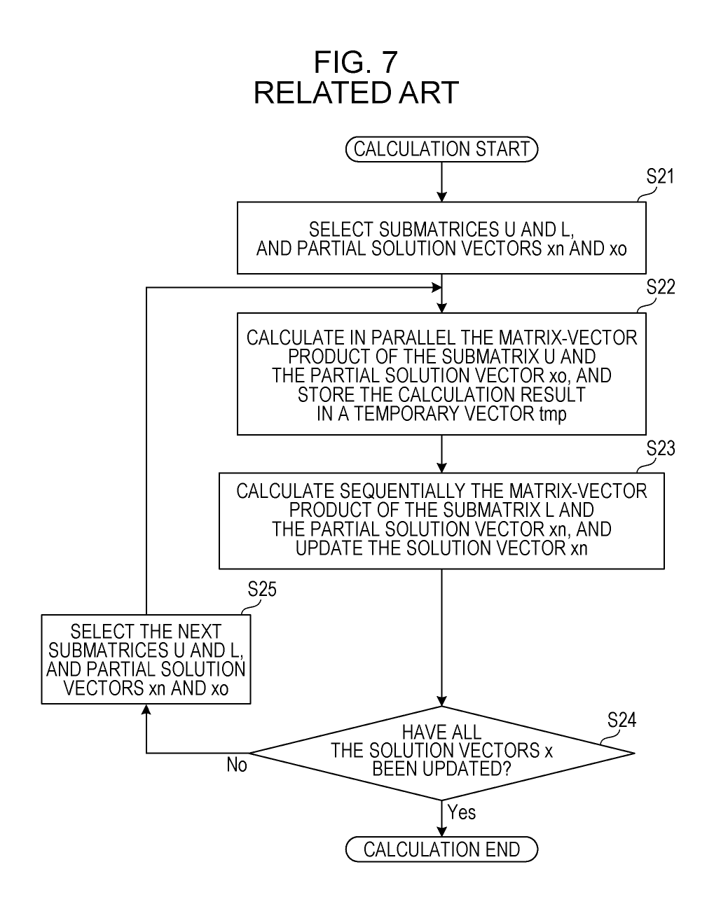

FIG. 7 is a flowchart illustrating an example of a processing flow by the related-art Gauss-Seidel method. In the following, a description will be given of a processing flow by the related-art Gauss-Seidel method with reference to FIG. 4 and FIG. 6.

In step S21, when the right-side parallel operation result data calculation unit 201 selects submatrices U and L, and partial solution vectors xn and xo, the processing proceeds to S22.

In step S22, the right-side parallel operation result data calculation unit 201 performs parallel calculation on the matrix vector product of the submatrix U and the partial solution vector xo and stores a calculation result into a temporary vector tmp, and the processing proceeds to S23.

In step S23, the left-side parallel operation result data calculation unit 202 performs sequential calculation on the matrix vector product of the submatrix L and the calculated partial solution vector xn and updates the solution vector xn, and the processing proceeds to S24.

In step S24, the left-side parallel operation result data calculation unit 202 determines whether or not all the solution vectors x are updated. If the left-side parallel operation result data calculation unit 202 determines that all the solution vectors x have not been updated, the left-side parallel operation result data calculation unit 202 selects the next submatrices U and L, and the partial solution vectors xn and xo, and the processing proceeds to S22. On the other hand, if the left-side parallel operation result data calculation unit 202 determines that all the solution vectors x have been updated, this processing is terminated.

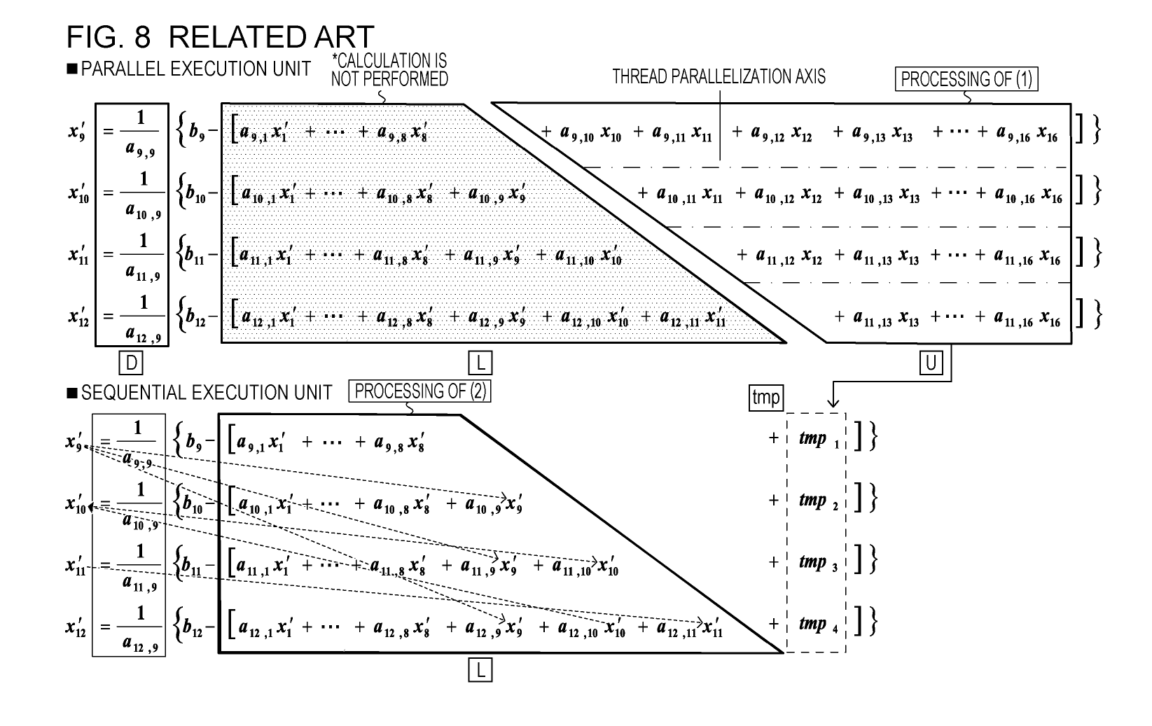

FIG. 8 is a diagram illustrating an example of calculation of a 16×16 matrix by the related-art Gauss-Seidel method.

The parallel execution unit performs parallel calculation on the submatrix U. The sequential execution unit performs sequential calculation on the submatrix L, calculates x′₉, and then when the sequential execution unit calculates x′₁₀, the sequential execution unit calculates x′₁₀ using x′₉. When the sequential execution unit calculates x′₁₁, the sequential execution unit calculates x′₁₁ using x′₉ and x′₁₀. Accordingly, the sequential execution unit is subjected to a restriction that the arrowed part is to be executed in order.

First, in the processing of (1), the parallel execution unit performs parallel calculation on the matrix vector product of the submatrix U and stores the result in the temporary vector tmp.

Next, in the processing of (2), the sequential execution unit performs sequential calculation of updating the solution vector x from the result of the matrix vector product of the submatrix L and the temporary vector tmp. Accordingly, in the sequential execution unit, the submatrix L to be subjected to the sequential calculation becomes bigger as the operation proceeds, and thus the amount of calculation of the sequential calculation increases. In the sequential execution unit, the amount of calculation of the sequential calculation increases so that the degree of parallelism decreases, and thus it becomes difficult to perform the processing at a high speed.

### EMBODIMENTS

In the following, a description will be specifically given of embodiments of the present disclosure with reference to the drawings. However, the present disclosure is not limited by the embodiments in any way.

### First Embodiment

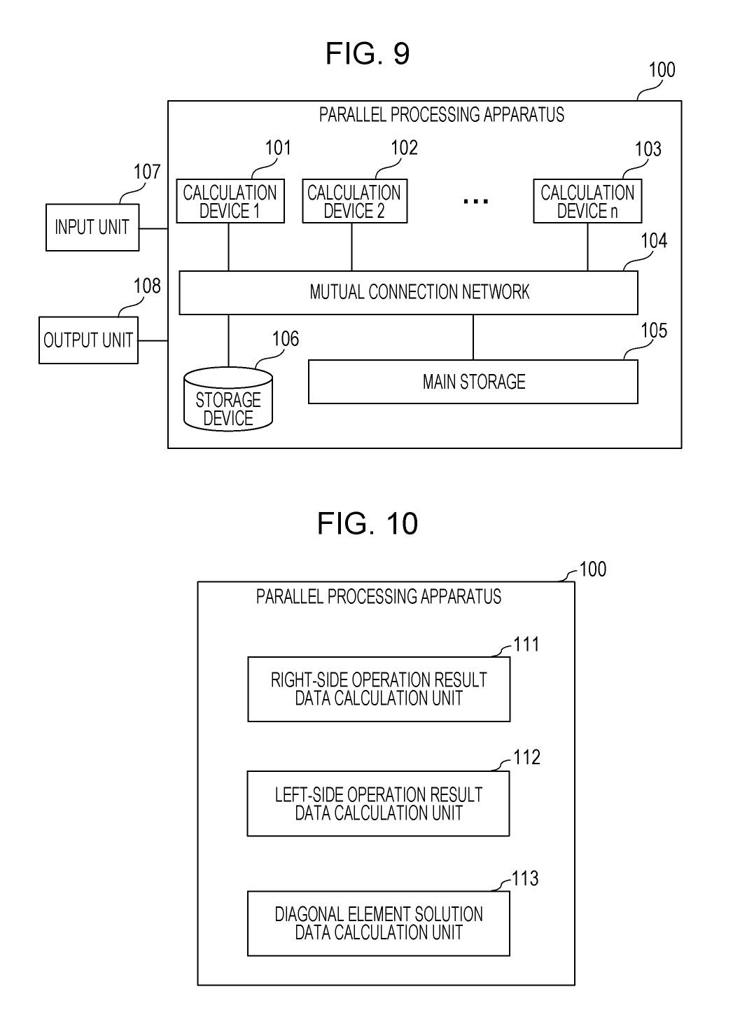

FIG. 9 is a diagram illustrating an example of the hardware configuration of a parallel processing apparatus according to the present disclosure. A parallel calculation program is recorded in a main storage and a storage device described later of a parallel processing apparatus 100 illustrated in FIG. 9. A calculation device described later reads and executes the program so as to operate as a right-side operation result data calculation unit 111, a left-side operation result data calculation unit 112, and a diagonal element solution data calculation unit 113 that are described later.

The parallel processing apparatus 100 is a shared memory type computer and includes a calculation device 1 101, a calculation device 2 102, . . . , a calculation device n 103, a main storage 105, and a storage device 106 that are mutually connected by a mutual connection network 104. An input unit 107 and an output unit 108 are connected to the parallel processing apparatus 100.

The calculation device 1 101, the calculation device 2 102, . . . , and the calculation device n 103 are units that execute various programs of the right-side operation result data calculation unit 111, the left-side operation result data calculation unit 112, and the diagonal element solution data calculation unit 113 that are stored in the main storage 105 and the storage device 106. Each of those units may be a processor, such as MPU (Micro Processor Unit), CPU (Central Processor Unit), etc.

The mutual connection network 104 is a device to which a plurality of devices are connected via a cable, or the like and which enables these devices to relay and transfer data among these devices so as to realize communication among the devices.

The main storage 105 includes, for example, a read only memory (ROM), a random access memory (RAM), or the like and stores each processing program that plays the role of the parallel processing apparatus 100 and data.

For the storage device 106, for example, a magnetic disk device, an optical disc device, a magneto-optical disk device, or the like is given. It is possible to store each processing program described above and data in the storage device 106 and to load the program into the main storage 105 to use the program if desired.

For the input unit 107, for example, a keyboard, a mouse, a pointing device, a touch panel, or the like is given, and the input unit 107 is used for inputting an instruction from a user. Also, the input unit 107 is used to input the recording contents of a portable recording medium by driving the portable recording medium.

For the output unit 108, for example, a display, a printer, or the like is given, and the output unit 108 is used for displaying the processing result, or the like to the user of the parallel processing apparatus 100.

In this regard, although not illustrated in FIG. 9, in order to increase in speed of the calculation processing, an accelerator, such as a graphics processing unit (GPU), a field-programmable gate array (FPGA), or the like may be used in the configuration.

Next, FIG. 10 is a block diagram illustrating an example of the entire parallel processing apparatus according to the present disclosure. The parallel processing apparatus 100 illustrated in FIG. 10 includes a right-side operation result data calculation unit 111, a left-side operation result data calculation unit 112, and a diagonal element solution data calculation unit 113.

The right-side operation result data calculation unit 111 performs parallel operation on the right side of the diagonal elements of the matrix data of predetermined row data for each row to calculate right-side operation result data.

The left-side operation result data calculation unit 112 performs parallel operation on the left side of the diagonal elements of the matrix data of predetermined row data for each row using the calculated solution data to calculate left-side operation result data.

The diagonal element solution data calculation unit 113 calculates diagonal element solution data of the matrix data of predetermined row data using the right-side operation result data and the left-side operation result data.

Here, the configuration of the right-side operation result data calculation unit 111, the left-side operation result data calculation unit 112, and the diagonal element solution data calculation unit 113 correspond to a parallel processing apparatus according to the present disclosure. The processing that carries out the right-side operation result data calculation unit 111, the left-side operation result data calculation unit 112, and the diagonal element solution data calculation unit 113 correspond to a parallel calculation method according to the present disclosure. The program that causes a computer to perform the processing of the right-side operation result data calculation unit 111, the left-side operation result data calculation unit 112, and the diagonal element solution data calculation unit 113 correspond to a parallel calculation program according to the present disclosure.

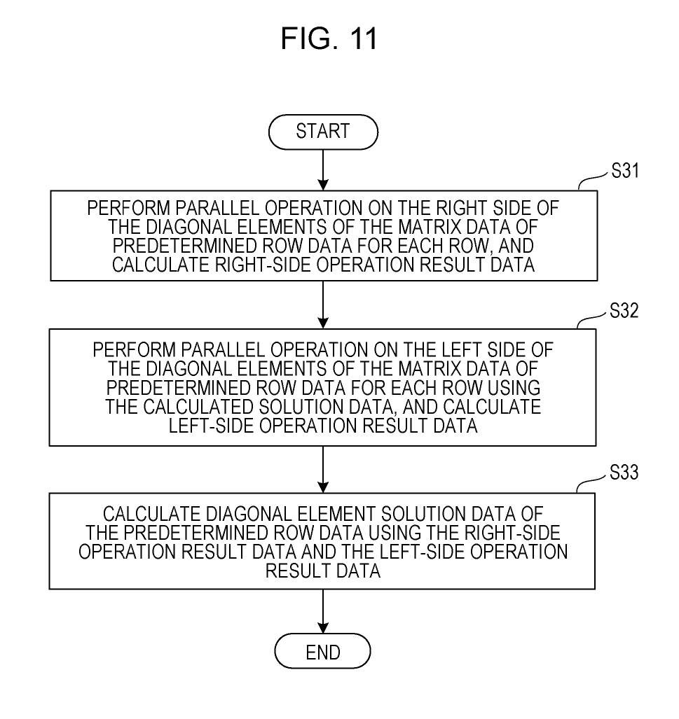

Here, FIG. 11 is a flowchart illustrating an example of the processing flow of the entire parallel processing apparatus according to the present disclosure. In the following, a description will be given of the processing flow of the entire parallel processing apparatus according to the present disclosure with reference to FIG. 10.

In step S31, the right-side operation result data calculation unit 111 performs parallel operation on the right side of the diagonal elements of the matrix data of predetermined row data for each row to calculate right-side operation result data, and the processing proceeds to S32.

In step S32, the left-side operation result data calculation unit 112 performs parallel operation on the left side of the diagonal elements of the matrix data of predetermined row data for each row using the calculated solution data to calculate left-side operation result data, and the processing proceeds to S33.

In step S33, the diagonal element solution data calculation unit 113 calculates solution data of the diagonal elements of the matrix data of predetermined row data using the right-side operation result data and the left-side operation result data, and this processing is terminated.

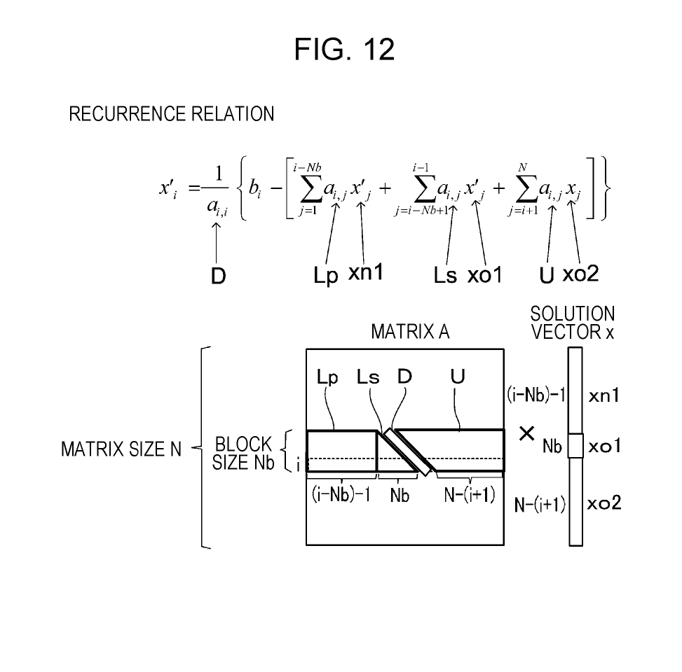

FIG. 12 is an explanatory diagram of an example of the Gauss-Seidel method according to the present disclosure.

First, in the Gauss-Seidel method, the parallel processing apparatus divides the L part of the recurrence relations into an Lp part and an Ls part.

Next, the parallel processing apparatus performs parallel calculation on the U part and the Lp part.

Next, the parallel processing apparatus performs sequential calculation on the Ls part, the D part, and update of the solution vector x.

Lp, Ls, and U in FIG. 12 are submatrices having a block size Nb in the matrix A having a matrix size N.

D is the diagonal elements having a block size Nb in the matrix A having a matrix size N.

Because the block size Nb is not fixed, and the matrix A includes zero elements and non-zero elements other than zeros, when calculation is performed, calculation is performed based on non-zero elements. Thus it is difficult to determine the block size Nb in the same way. Accordingly, the block size Nb is suitably determined in accordance with the number of non-zero elements.

The submatrix U is the right side of the diagonal elements D of the matrix data of predetermined row data.

The submatrix Lp is the left side of the diagonal elements D of the matrix data of the predetermined row data.

The solution vector x includes partial solution vectors xn1, xo1, and xo2. The partial solution vector xn1 refers to the calculated solution data. The partial solution vector xo1 is the solution data of the diagonal elements D of the predetermined row data.

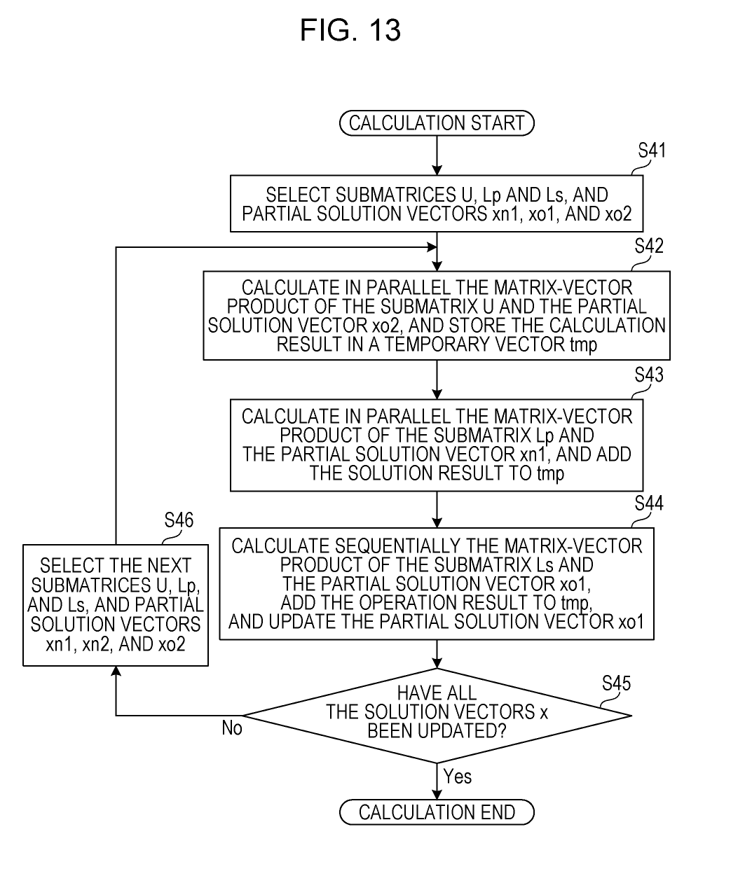

FIG. 13 is a flowchart illustrating an example of the processing flow by the Gauss-Seidel method according to the present disclosure. In the following, a description will be given of the processing flow by the Gauss-Seidel method according to the present disclosure with reference to FIG. 10 and FIG. 12.

In step S41, the right-side operation result data calculation unit 111 selects the submatrices U, Lp, and Ls, and the partial solution vectors xn1, xo1, and xo2, and the processing proceeds to S42.

In step S42, the right-side operation result data calculation unit 111 performs parallel calculation on the matrix vector product of the submatrix U and the partial solution vector xo2, and stores the calculation result in the temporary vector tmp, and the processing proceeds to S43.

In step S43, the left-side operation result data calculation unit 112 performs parallel calculation on the matrix vector product of the submatrix Lp and the partial solution vector xn1 and adds the calculation result to the temporary vector tmp, and the processing proceeds to S44.

In step S44, the diagonal element solution data calculation unit 113 performs sequential calculation on the matrix vector product of the submatrix Ls and the partial solution vector xo1 and adds the calculation result to the temporary vector tmp to update the partial solution vector xo1, and the processing proceeds to S45.

In step S45, the diagonal element solution data calculation unit 113 determines whether or not all the solution vectors x have been updated. If the diagonal element solution data calculation unit 113 determines that not all the solution vectors x have been updated, the diagonal element solution data calculation unit 113 selects the next submatrices U, Lp, and Ls, and partial solution vectors xn1, xo1, and xo2, and the processing proceeds to S42. On the other hand, if the diagonal element solution data calculation unit 113 determines that all the solution vectors x have been updated, this processing is terminated.

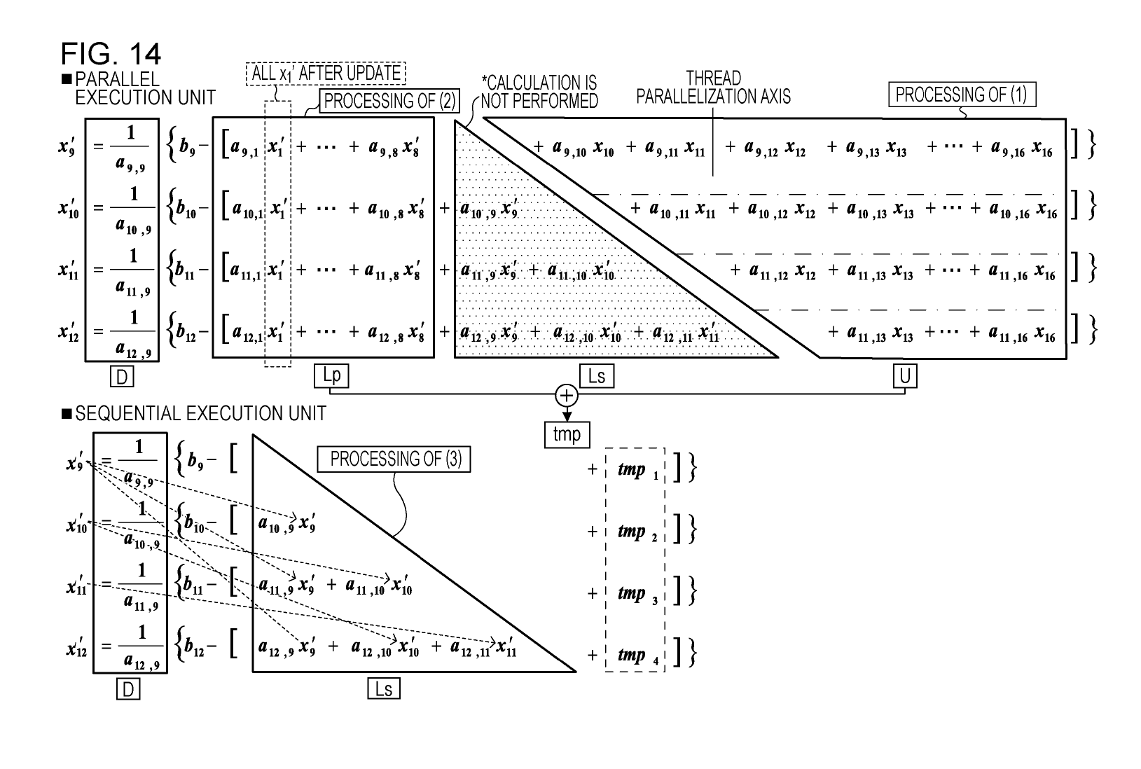

FIG. 14 is a diagram illustrating an example of calculation of a 16×16 matrix by the Gauss-Seidel method according to the present disclosure.

The parallel execution unit performs parallel calculation on the submatrix U. The parallel execution unit performs parallel calculation on the submatrix Lp. Then, x′₁ to x′₈ have been calculated before x′₉ is calculated.

The sequential execution unit performs sequential calculation on the submatrix Ls.

First, in the processing in (1), the parallel processing apparatus using the Gauss-Seidel method performs parallel calculation on the matrix vector product of the submatrix U and stores the result in the temporary vector tmp.

Next, in the processing in (2), the parallel processing apparatus performs parallel calculation on the matrix vector product of the submatrix Lp and adds the result to the temporary vector tmp.

Next, in the processing in (3), the parallel processing apparatus performs sequential calculation on update of the solution vector x from the result of the submatrix Ls, the matrix vector product, and the temporary vector tmp.

In FIG. 14, as compared with FIG. 8, L is divided into Lp and Ls, and it is possible to perform parallel calculation on Lp. Accordingly, only Ls is subjected to sequential calculation, and thus it is possible to execute the processing at a high speed by parallelization.

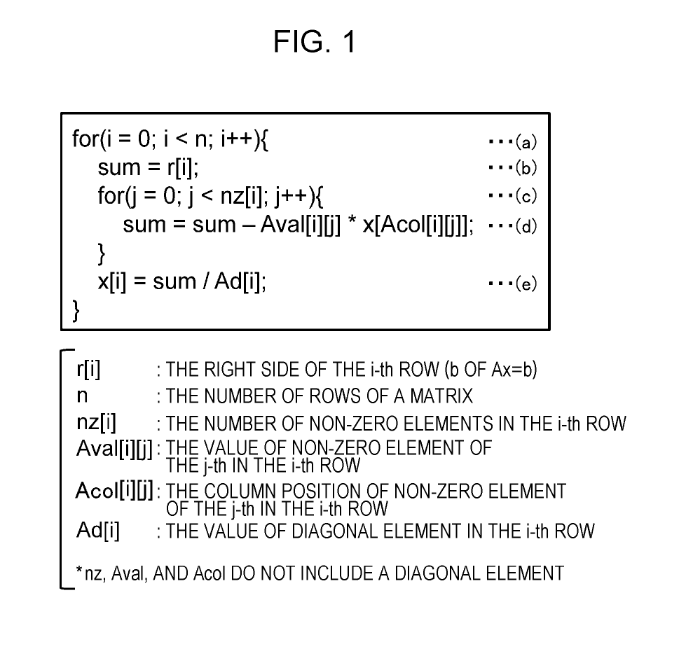

Here, a description will be given again of the processing by the Gauss-Seidel method illustrated in FIG. 1.

First, in the Gauss-Seidel method, when a point in time at which execution of i=i1-th row is started is considered, the values of the elements x[0] to x[i1−1] of the vector x have been updated by the calculation of up to i=(i1−1)-th row. Hereinafter the fact that a value has already been updated is referred as “the value is “NEW””.

On the other hand, the values of the elements x[i1] to x[n−1] have not been updated. Hereinafter the fact that a value has not been updated is referred to as “the value is “OLD””.

Next, in the Gauss-Seidel method, when i=i1-th row is executed, if x[Acol[i][j]] of (d) in FIG. 1 satisfies: 0≤Acol[i1][j]≤i1−1, the value of the x[Acol[i][j]] is “NEW”.

On the other hand, in the Gauss-Seidel method, if i1+1≤Acol[i1][j]≤n−1, the value of x[Acol[i][j]] of (d) in FIG. 1 is “OLD”. That is to say, in the Gauss-Seidel method, it is possible to divide the product difference calculation of i=i1-th row of (d) in FIG. 1 into parts having x[Acol[i][j]] that are only “NEW” and parts having x[Acol[i][j]] that are only “OLD”.

It is possible to calculate the parts that are only “OLD” while the elements x[i1+1] to x[n−1] are “OLD”, that is to say, any time (for example, from the time when the elements x[0] to x[n−1] are still “OLD”) before the elements x[i+1] become “NEW”.

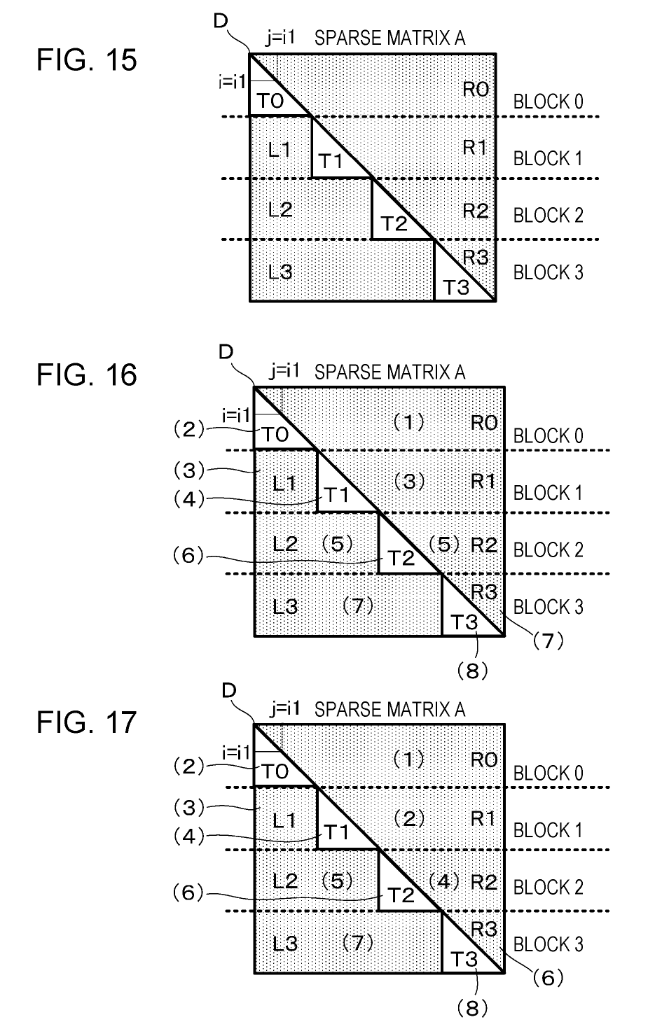

Based on the above, the sparse matrix A is divided as illustrated in FIG. 15. In FIG. 15, the sparse matrix A is divided into four blocks, that is to say, blocks 0 to 3 in the row direction. Further, each block is divided into lower triangular areas T0, T1, T2, and T3 along the diagonal D and the other right side areas R0, R1, R2, and R3, and left side areas L1, L2, and L3.

In the sparse matrix A illustrated in FIG. 15, calculation is executed in order of block 0, block 1, block 2, and block 3.

First, in block 0, the element x[i] used for calculation with the non-zero elements in the lower triangular area T0 of the sparse matrix A is “NEW”.

The element x[i] used for calculation with the non-zero elements in the right side area R0 of the lower triangular area T0 of the sparse matrix A is “OLD”. Accordingly, if calculation of each row is divided into “NEW” and “OLD”, it is possible to determine the execution order in block 0 as the order of the right side area R0 of the lower triangular area and the lower triangular area T0. Also, it is possible to execute in parallel all the rows of right side area R0 in the lower triangular area at the same time. On the other hand, it is possible to perform sequential execution on the lower triangular area T0.

Next, for block 1, the right side area R1 of the lower triangular area T1 is “OLD”, and thus it is possible to execute in parallel all the rows at the same time.

It is possible to refer to the elements of the vector x that are already “NEW” in block 0, and thus it is possible to perform parallel execution on all the rows in the left side area L1 in the lower triangular area in block 1 at the same time. That is to say, in the right side area R1 and the left side area L1 of the lower triangular area, it is possible to perform parallel execution on all the rows in block 1 at the same time, and to perform sequential execution on the lower triangular area T1.

As a result, in block 1, in the same manner as block 0, it is possible to execute in order of the right side area R1, the left side area L1 of the lower triangular area, and the lower triangular area T1. Also, it is possible to execute in parallel all the rows of the right side area R1 and the left side area L1 of the lower triangular area.

Next, for block 2, the right side area R2 of the lower triangular area T2 is “OLD”, and thus it is possible to execute in parallel all the rows at the same time.

It is possible to refer to the elements of the vector x that are already “NEW” in block 1, and thus it is possible to perform parallel execution on all the rows of the left side area L2 of the lower triangular area T2 in block 2 at the same time. That is to say, the right side area R2 and the left side area L2 in the lower triangular area, it is possible to perform parallel execution on all the rows in block 2 at the same time, and to perform sequential execution on the lower triangular area T2.

As a result, in block 2, in the same manner as blocks 0 and 1, it is possible to execute in order of the right side area R2, the left side area L2 of the lower triangular area, and the lower triangular area T2. Also, it is possible to execute in parallel all the rows of the right side area R2 and the left side area L2 of the lower triangular area.

Next, for block 3, the right side area R3 of the lower triangular area T3 is “OLD”, and thus it is possible to execute in parallel all the rows at the same time.

It is possible to refer to the elements of the vector x that are already “NEW” in block 2, and thus it is possible to perform parallel execution on all the rows of the left side area L3 of the lower triangular area T3 in block 3. That is to say, in the right side area R3 and the left side area L3 of the lower triangular area, it is possible to perform parallel execution on all the rows in block 3 at the same time, and to perform sequential execution on the lower triangular area T3.

As a result, in block 3, in the same manner as blocks 0, 1, and 2, it is possible to execute in order of the right side area R3, the left side area L3 of the lower triangular area, and the lower triangular area T3. Also, it is possible to execute in parallel all the rows of the right side area R3 and the left side area L3 of the lower triangular area.

Accordingly, without changing the update order (updating from elements x[0] to x[n−1] in order) of the vector x, it is possible to perform parallel execution on the right side areas R0, R1, R2, and R3 and the left side areas L1, L2, and L3 excluding the lower triangular areas T0, T1, T2, and T3 in the order from (1) to (8) illustrated in FIG. 16.

Specifically, N processors, namely processors 0 to (N−1), perform parallel execution on a sparse matrix A as illustrated in FIG. 16. In this regard, FIG. 16 is the case where N=4.

First, (1) the processors 0 to (N−1) perform parallel execution on the right side area R0 of the lower triangular area T0.

Next, (2) the processor 0 performs sequential execution on the lower triangular area T0.

Next, (3) the processors 0 to (N−1) perform parallel execution on the right side area R1 and the left side area L1 of the lower triangular area T1.

Next, (4) the processor 0 performs sequential execution on the lower triangular area T1.

Next, (5) the processors 0 to (N−1) perform parallel execution on the right side area R2 and the left side area L2 of the lower triangular area T2.

Next, (6) the processor 0 performs sequential execution on the lower triangular area T2.

Next, (7) the processors 0 to (N−1) perform parallel execution on the right side area R3 and the left side area L3 of the lower triangular area T3.

Finally, (8) the processor 0 performs sequential execution on the lower triangular area T3.

As described above, by the first embodiment, it is possible to parallelize the Gauss-Seidel method for a sparse matrix and execute the processing at a high speed. In this regard, in the present embodiment, a description has been given of parallel processing by the processors. However, it is also possible to apply the method to the parallel processing of nodes and parallel processing of cores in a processor.

### Second Embodiment

In the first embodiment, as illustrated in FIG. 16, the lower triangular area T0, T1, T2, and T3 are executed only by the processor 0, and the remaining processors 1 to (N−1) are in an idle state. Thus, in a second embodiment, N processors, namely processors 0 to (N−1), perform parallel execution on a sparse matrix A as illustrated in FIG. 17. In this regard, FIG. 17 is the case where N=4.

First, (1) the processors 0 to (N−1) perform parallel execution on the right side area R0 of the lower triangular area T0.

Next, (2) the processor 0 performs sequential execution on the lower triangular area T0, and at the same time, the processors 1 to (N−1) perform parallel execution on the right side area R1 of the lower triangular area T1.

Next, (3) the processors 0 to (N−1) perform parallel execution on the left side area L1 of the lower triangular area T1.

Next, (4) the processor 0 performs sequential execution on the lower triangular area T1, and at the same time, the processors 1 to (N−1) perform parallel execution on the right side area R2 of the lower triangular area T2.

Next, (5) the processors 0 to (N−1) perform parallel execution on the left side area L2 of the lower triangular area T2.

Next, (6) the processor 0 performs sequential execution on the lower triangular area T2, and at the same time, the processors 1 to (N−1) perform parallel execution on the right side area R3 of the lower triangular area T3.

Next, (7) the processors 0 to (N−1) perform parallel execution on the left side area L3 of the lower triangular area T3.

Finally, (8) the processor 0 performs sequential execution on the lower triangular area T3.

In this manner, the processing executed only by the processor 0 becomes only the lower triangular area T3.

By the second embodiment, it is possible to reduce the number of the processors that are in the idle state and to parallelize the Gauss-Seidel method for a sparse matrix and to execute the processing at a high speed.

### Third Embodiment

In a third embodiment, N processors, namely processors 0 to (N−1) perform parallel execution on a sparse matrix A as illustrated in FIG. 16 in the same manner as the first embodiment except that the SOR method is used in place of the Gauss-Seidel method. In this regard, FIG. 16 is the case where N=4. The SOR method differs from the Gauss-Seidel method according to the first embodiment only in the point that an acceleration parameter ω (1<ω<2) is introduced.

By the third embodiment, it is possible to reduce the idle state of the processors, and parallelize the SOR method for a sparse matrix so as to perform the method at a higher speed.

### Fourth Embodiment

In a fourth embodiment, N processors, namely processors 0 to (N−1) perform parallel execution on a sparse matrix A as illustrated in FIG. 17 in the same manner as the second embodiment except that the SOR method is used in place of the Gauss-Seidel method. In this regard, FIG. 17 is the case where N=4. The SOR method differs from the Gauss-Seidel method according to the first embodiment only in the point that an acceleration parameter ω (1<ω<2) is introduced. By the fourth embodiment, it is possible to parallelize the SOR method for a sparse matrix so as to perform the processing at a higher speed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A parallel processing apparatus for performing operation for each row data of matrix data and outputting solution data for each row, for solving matrix simultaneous linear equations, by using at least one of the Gauss-Seidel method and the successive over-relaxation method (SOR method), the apparatus comprising:
a memory, and
a processor coupled to the memory and configured to execute a process including:
performing parallel operation on elements at a right side of diagonal elements of the matrix data for each of rows of the row data to calculate right-side operation result data;
performing parallel operation on elements at a left side of the diagonal elements of the matrix data for each of rows of the row data using a solution data to calculate left-side operation result data; and
calculating the solution data of the diagonal elements of the matrix data of the row data using the right-side operation result data and the left-side operation result data.

2. The parallel processing apparatus according to claim 1, while performing the calculating the solution data for the row data, performing, in parallel, the parallel operation to calculate the right-side operation result data for next row data of the matrix data.

3. A computer-implemented parallel processing method for performing operation for each row data of matrix data and outputting solution data for each row, for solving matrix simultaneous linear equations, by using at least one of the Gauss-Seidel method and the successive over-relaxation method (SOR method) using matrix data, the parallel operation method comprising:
performing parallel operation on elements at a right side of diagonal elements of the matrix data for each of rows of the row data to calculate right-side operation result data;
performing parallel operation on elements at a left side of the diagonal elements of the matrix data for each of rows of the row data using a solution data to calculate left-side operation result data; and
calculating the solution data of the diagonal elements of the matrix data of the row data using the right-side operation result data and the left-side operation result data.

4. The parallel processing method according to claim 3,
while performing the calculating the solution data for the row data, performing, in parallel, the parallel operation to calculate the right-side operation result data for next predetermined row data of the matrix data.

5. A non-transitory computer-readable storage medium storing a parallel processing program for causing a computer to perform a process for solving matrix simultaneous linear equations, by using at least one of the Gauss-Seidel method and the successive over-relaxation method (SOR method) using matrix data, the process comprising:
performing parallel operation on elements at a right side of diagonal elements of matrix data for each of rows of row data to calculate right-side operation result data;
performing parallel operation on elements at a left side of the diagonal elements of the matrix data for each of rows of the row data using a solution data to calculate left-side operation result data; and
calculating the solution data of the diagonal elements of the matrix data of the row data using the right-side operation result data and the left-side operation result data.

6. The storage medium according to claim 5,
while performing the calculating the solution data for the row data, performing, in parallel, the parallel operation to calculate the right-side operation result data for next row data of the matrix data.

7. A parallel processing apparatus comprising:
a memory; and
a processor coupled to the memory and configured to execute a process including:
dividing a matrix of data into a plurality of processing areas of data including a diagonal area, left submatrix, right submatrix, and triangle area;
processing, in parallel, the left submatrix and right submatrix;
sequentially processing the triangle area of data;
provide solution data for the matrix of data by repeatedly performing the dividing, processing, and sequentially processing for each row of data within the matrix of data.

8. The parallel processing apparatus according to claim 7, wherein the triangle area is immediately left of the diagonal area, the left submatrix is data left of the diagonal area and the triangle area, the right submatrix is right of the diagonal area.

9. The parallel processing apparatus according to claim 7, wherein the processing, and sequentially processing are operations of at least one of the Gauss-Seidel method and the successive over-relaxation method (SOR method).

10. The parallel processing apparatus according to claim 7, wherein the matrix data is at least one of fluid analysis data and structural analysis data.
